(19) United States
(12) Patent Application Publication
(10) Pub. No.: US 2004/0198861 A1
(43) Pub. Date: Oct. 7, 2004

(54) Photocurable and thermosetting resin composition

(76) Inventors: Yoshihiro Ohno, Iruma-gun (JP); Masami Matsumura, Hiki-gun (JP); Satoru Iwaida, Sakado-shi (JP); Masayuki Isono, Hidaka-shi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/828,213

(22) Filed: Apr. 21, 2004

Related U.S. Application Data
(63) Continuation of application No. PCT/JP02/10856, filed on Oct. 18, 2002.

(30) Foreign Application Priority Data
Oct. 22, 2001 (JP) 2001-323634

(51) Int. Cl. C08J 3/28

(52) U.S. Cl. 522/79

(57) ABSTRACT

A photocurable and thermosetting resin composition comprises a photocurable component, a thermosetting component, and a solvent component, wherein the solvent component contains a compound which exhibits a critical value of the water solubility at 25° C. of 3.0 to 0.1% by weight, preferably 2.5 to 0.1% by weight, and which is represented by the following general formula (1), preferably in the proportion of not less than 50% by weight of the solvent component:

R¹COO—(C₃H₆O)ₙ—R² (1)

wherein, R¹ and R² may be identical or different from each other and independently represent an alkyl group having 1 to 4 carbon atoms, and n represents an integer of 1 or 2.

### CROSS-REFERENCE TO RELATED APPLICATIONS

This is a continuation of Application PCT/JP02/10856, filed Oct. 18, 2002, now abandoned.

### BACKGROUND OF THE INVENTION

1. Field of the Invention

This invention relates to a photocurable and thermosetting resin composition which scarcely generates a scum, particularly a photocurable and thermosetting resin composition useful as a protective mask for a printed circuit board.

2. Description of the Prior Art

In the formation of a solder resist in a household grade printed circuit board and in an industrial grade printed circuit board, for the purpose of coping with the fineness and high densification of conductor patterns of various printed circuit boards, a photocurable and alkali-developable liquid solder resist ink which excels in resolution and dimensional accuracy is widely used.

As such a photocurable solder resist ink, for example, published Japanese Patent Application, KOKAI (Early Publication) No.61-243,869 (corresponding to U.S. Pat. No. 5,009,982 issued Apr. 23, 1991 to Kamayachi et al) discloses a photocurable and thermosetting liquid solder resist ink composition comprising an alkali-soluble and active energy ray-curable resin obtained by reacting a saturated or unsaturated polybasic acid anhydride to a reaction product of a novolak type epoxy compound with an unsaturated monocarboxylic acid, a photopolymerization initiator, a diluent, and an epoxy compound.

### SUMMARY OF THE INVENTION

In recent years, a thinner resist layer has been formed to cope with the recent remarkable trend of a printed circuit board toward fine conductor patterns. As a result, the problem that the undeveloped resist remains partially in the part which is not desired to be covered with the resist, particularly in the periphery of edge of a via-hole (VH) or a through-hole (TH) at which the film thickness become thin, i.e. generation of the so-called ring-like scum (hereinafter referred to briefly as a scum) becomes obvious.

Since the generation of such a scum brings such a disadvantage that the solder adhesion and the plate adhesion become poor, the desirability of developing the resist which scarcely generates a scum has been finding growing recognition.

The present invention has been made under such circumstances and has an object of providing a photocurable and thermosetting resin composition which is useful in forming various resists, particularly a solder resist film, capable of suppressing the generation of a scum, and capable of improving the solder adhesion and the plate adhesion.

To accomplish the object mentioned above, the present invention provides a photocurable and thermosetting resin composition comprising a photocurable component, a thermosetting component, and a solvent component, wherein the solvent component contains a compound which exhibits a critical value of the water solubility at 25° C. of 3.0 to 0.1% by weight, preferably not more than 2.5% by weight, and which is represented by the following general formula (1), preferably in the proportion of not less than 50% by weight of the solvent component:

R¹COO—(C₃H₆O)ₙ—R² (1)

wherein, R¹ and R²may be identical or different from each other and independently represent an alkyl group having 1 to 4 carbon atoms, and n represents an integer of 1 or 2.

In a particularly preferred embodiment, the compound represented by the above-mentioned general formula (1) is dipropylene glycol monoalkyl ether acetate, preferably dipropylene glycol monomethyl ether acetate.

Since the photocurable and thermosetting resin composition of the present invention contains as a main solvent ingredient the alkyl ether ester compound of propylene glycol which exhibits a high boiling point and the critical value of the water solubility at 25° C. of 3.0 to 0.1% by weight as described above, it allows the suppression of generation of a scum and is effective in preventing the soldering and plating from poor adhesion.

### DETAILED DESCRIPTION OF THE INVENTION

The present inventors, after pursuing a diligent study to develop a photocurable and thermosetting resin composition which is capable of suppressing the generation of a scum, have found that the aforementioned object can be accomplished by a photocurable and thermosetting resin composition which contains a photocurable component, a thermosetting component, and a solvent component, preferably the photocurable and thermosetting resin composition comprising in combination (A) a photosensitive prepolymer having a carboxyl group and at least two ethylenically unsaturated bonds in its molecule, (B) a photopolymerization initiator, (C) a thermosetting compound, (D) a solvent component, and if needed (E) a photopolymerizable monomer, in which the solvent component (D) contains a compound which exhibits a critical value of the water solubility at 25° C. of 3.0 to 0.1% by weight, preferably 2.5 to 0.1% by weight, and which is represented by the general formula (1) mentioned above, preferably in a proportion of not less than 50% by weight of the solvent component. As the result, the present invention has been perfected.

Here, the critical value of the water solubility is defined by the amount of water added to a solvent (the ratio of water to a solvent) at the time the solvent begins to become cloudy as a whole when water is gradually added to 100 parts by weight of the solvent kept at 25° C. while shaking it vigorously.

As the factors of generation of a scum, (1) the influence of humidity (the scum tends to generate at the high humidity conditions), (2) the influence of film thickness (the scum tends to generate in the case of a thin film), and (3) leaving to stand of the resist after application (the scum tends to generate when the leaving time becomes long) may be cited as the process factors. On the other hand, from the viewpoint of the composition of the resist, (4) to lower the molecular weight of an epoxy resin is effective in preventing the generation of scum. However, it will bring another disadvantage of impairing the tack-free touch of a coating film. Besides, there is another method of (5) lowering the amount of a thermosetting catalyst to be added. However, this method will bring such a problem that the resistance to soldering and the resistance to plating will be deteriorated.

The solvents having the basic structure of ethylene glycol or diethylene glycol, such as ethylene glycol monoethyl ether acetate (popular name, Cellosolve acetate) and diethylene glycol monoethyl ether acetate (popular name, Carbitol acetate) which are conventionally used as a solvent component of a photocurable and thermosetting resin composition, are susceptible to moisture. Therefore, the composition containing such a solvent tends to bring such disadvantages as the decrease of resolution and the generation of a scum at the time of forming a circuit pattern and further such a problem of gelation or solidification of the composition during a long-term preservation.

The present inventors, after pursuing a diligent study of the relation between the water affinity of an organic solvent and various properties to develop a photocurable and thermosetting resin composition which is hardly susceptible to humidity, have found that the solubility of a solvent in water is greatly related to the above-mentioned disadvantages and problems and that the use of the solvent exhibiting the water solubility not more than a certain critical value is effective in eliminating the disadvantages and problems mentioned above.

That is to say, the present invention solves the disadvantages and problems due to the solvent component of a photocurable and thermosetting resin composition by using mainly a specific solvent which exhibits the critical value of the water solubility of 3.0 to 0.1% by weight, preferably 2.5-0.1% by weight.

By using the solvent which exhibits the critical value of the water solubility of not more than 3.0% by weight as described above, the effects of suppressing the generation of a scum and overcoming the drawbacks of poor solder adhesion and poor plate adhesion are acquired, for example, in a solder resist that is formed by exposing a coating film to light to form an image pattern and removing the unexposed portions thereof with a dilute aqueous alkaline solution.

If a solvent which exhibits the critical value of the water solubility less than 0.1% by weight (for example, a petroleum solvent) is used in a large amount, however, it is capable of dissolving the above-mentioned photosensitive prepolymer only with difficulty. Further, it is at a disadvantage of causing such problems that the penetration power of a developing solution into the coating film is lowered and the break point at the time of development (a period of time from the start of development to the complete removal of an unexposed portion of the coating film under a certain prescribed developing condition) becomes long, thereby remaining the undeveloped residues in through-holes, for example.

As the solvent which exhibits the critical value of the water solubility of 3.0 to 0.1% by weight, an alkyl ether ester compound of propylene glycol represented by the above-mentioned general formula (1), for example, propylene glycol monoethyl ether acetate, propylene glycol monoethyl ether propionate, dipropylene glycol monomethyl ether acetate, dipropylene glycol monoethyl ether acetate, dipropylene glycol monomethyl ether propionate, etc. may be cited. These solvents may also be used in the form of a combination of two or more members. Besides these solvents, ketones such as ethyl-n-butyl ketone, di-n-propyl ketone, and di-isobutyl ketone may be cited. One or more of these ketones may be used by combining with the alkyl ether ester compound of propylene glycol mentioned above. Particularly, in view of various properties of the composition, such as the solubility, evaporation speed, and resolution, it is desirable to use the alkyl ether ester compound of propylene glycol as the main ingredient of the solvent component. From the view point of a change in viscosity with the passage of time and the solubility of a resin, dipropylene glycol monomethyl ether acetate of which boiling point is 209° C. and which exhibits the slow evaporation speed proves to be particularly desirable. Incidentally, dipropylene glycol monomethyl ether acetate available from the Dow Chemical Co. is DOWANOL DPMA.

In addition, in order to suppressing the change in viscosity, the change in film thickness, and the like due to the volatilization of an organic solvent at the time of preparation of the photocurable and thermosetting resin composition of the present invention and at the time of application thereof by the screen printing, for example, it is desirable to use the solvent having a boiling point of 150° C. or more.

The ratio of combination of the aforementioned compound which is represented by the general formula (1) mentioned above and exhibits the critical value of the water solubility at 25° C. in the range of 3.0 to 0.1% by weight to the above-mentioned curing components (the photosensitive prepolymer (A), the photopolymerizable monomer (E) and the thermosetting compound (C)) is desired to be in the range of 5 to 500 parts by weight, preferably 10 to 300 parts by weight, based on 100 parts by weight of the curing components. The amount of the compound less than 5 parts by weight is not desirable because the viscosity of the resultant composition will be so high as to allow the uniform stirring and application of the composition only with difficulty. Conversely, if the amount of the compound exceeds 500 parts by weight, the viscosity of the composition becomes so low as to lack in practicality.

It is preferable that the photocurable and thermosetting resin composition of the present invention should contain the solvent having a boiling point of 150° C. or more and exhibiting the critical value of the water solubility at 25° C. of 3.0 to 0.1% by weight as mentioned above, such as dipropylene glycol monomethyl ether acetate, in an amount of not less than 50 parts by weight, based on 100 parts by weight of the solvent component (D).

Further, the photocurable and thermosetting resin composition of the present invention may incorporate therein, as occasion demands for the purpose of adjusting the drying rate or the like, an organic solvent commonly used in a photocurable and thermosetting resin composition other than the solvents mentioned above, such as ketones, acetic acid esters, glycol ethers, and petroleum solvents, in an amount not so large as to impair the effects of the present invention, for example, in an amount of not more than 50 parts by weight, based on 100 parts by weight of the solvent component (D). As concrete examples of these organic solvents, hexane, heptane, octane, nonane, decane, benzene, toluene, xylene, these hydrocarbon solvents substituted by an alkyl group, benzyl alcohol, methyl ethyl ketone, cyclohexanone, methyl propionate, methyl benzoate, propyl butylate, etc. may be cited. These solvents may be used either singly or in the form of a mixture of two or more members.

In the photocurable and thermosetting resin composition of the present invention, a photocurable component, such as a photosensitive prepolymer and a photopolymerizable monomer, and a thermosetting component such as an epoxy resin are used as the curing components.

As the photosensitive prepolymer (A), those having a carboxyl group and at least two ethylenically unsaturated bonds in its molecule and capable of being developed with an aqueous alkaline solution may be advantageously used. As such photosensitive prepolymers, the photosensitive carboxylated prepolymers obtained by reacting an epoxy resin such as, for example, bisphenol F type epoxy resins, bisphenol A type epoxy resins, hydrogenated bisphenol A type epoxy resins, 1,4-butanediol diglycidyl ether, glycerin triglycidyl ether, phenol novolak type epoxy resins, cresol novolak type epoxy resins, naphthalene type epoxy resins, biphenyl type epoxy resins, heterocyclic epoxy resins, and glycidyl methacrylate copolymeric epoxy resins, with an ethylenically unsaturated monocarboxylic acid such as, for example, acrylic acid, methacrylic acid, crotonic acid, and cinnamic acid, and then further reacting the resultant epoxy acrylate compound (a partially acrylated compound or completely acrylated compound) with a polybasic acid anhydride such as, for example, maleic anhydride, phthalic anhydride, tetrahydrophthalic anhydride, hexahydrophthalic anhydride, and 3,6-endomethylene tetrahydrophthalic anhydride may be advantageously used.

Besides the photosensitive prepolymers mentioned above, any of other photosensitive prepolymers as listed below may be used and not limited to particular photosensitive prepolymers:

(1) a carboxyl group-containing photosensitive resin obtained by adding an ethylenically unsaturated group as a pendant to a copolymer of an unsaturated carboxylic acid and an unsaturated double bond-containing compound,

(2) a carboxyl group-containing photosensitive resin obtained by reacting an unsaturated carboxylic acid with a copolymer of a compound having an epoxy group and an unsaturated double bond and an unsaturated double bond-containing compound and further reacting a polybasic acid anhydride with the resultant secondary hydroxyl group,

(3) a carboxyl group-containing photosensitive resin obtained by reacting a compound having a hydroxyl group and an unsaturated double bond with a copolymer of an unsaturated double bond-containing acid anhydride and an unsaturated double bond-containing compound,

(4) a carboxyl group-containing photosensitive resin obtained by further reacting a compound having an epoxy group and an unsaturated double bond with a carboxyl group-containing resin obtained by the reaction of a polybasic acid anhydride with a hydroxyl group-containing polymer, and

(5) a carboxyl group-containing photosensitive resin obtained by reacting an unsaturated monocarboxylic acid with a polyfunctional oxetane compound and further reacting a polybasic acid anhydride with a primary hydroxyl group of the resultant modified oxetane resin.

The photocurable and thermosetting resin composition of the present invention, when necessary, may incorporate therein a photopolymerizable monomer (E) for the purpose of improving the photocuring properties of the composition. As the photopolymerizable monomers, polyfunctional monomers such as hydroxyethyl acrylate, hydroxypropyl acrylate, 2-ethyl hexyl acrylate, benzyl acrylate, ethylene glycol diacrylate, 1,6-hexanediol diacrylate, an adduct of bisphenol A diglycidyl ether with two mols of acrylic acid, trimethylol propane triacrylate, pentaerythritol triacrylate, pentaerythritol tetraacrylate, dipentaerythritol pentaacrylate, and dipentaerythritol hexaacrylate may be advantageously used. However, the photopolymerizable monomer is not limited to these compounds.

The amount of the photopolymerizable monomer (E) to be incorporated in the composition is desired to be not more than 60 parts by weight, based on 100 parts by weight of the photosensitive prepolymer (A). The amount of the photopolymerizable monomer exceeding the upper limit mentioned above is not desirable because a tack-free touch of finger of a coating film will be impaired.

As the photopolymerization initiators (B), for example, benzoin ethers such as benzoin methyl ether, benzoin isopropyl ether, and benzoin phenyl ether; benzophenones such as benzophenone and N,N-tetramethyl-4,4-diaminobenzophenone; acetophenones such as 2,2-dimethoxy-2-phenyl acetophenone and p-tert-butyl dichloroacetophenone; 1-(4-isopropyl phenyl)-2-hydroxy-2-methylpropan-1-one, 2-methyl-1-[4-(methylthio)phenyl]-2-morpholinopropan-1-one, and 2,2-dimethoxy-1,2-diphenylethan-1-one may be cited. However, the photopolymerization initiator is not limited to these compounds. These known photopolymerization initiators may be used either singly or in the form of a combination of two or more members.

The amount of the photopolymerization initiator (B) to be incorporated in the composition is preferred to be in the range of 0.5 to 20% by weight of the total amount of the photocurable components (the photosensitive prepolymer (A) and the photopolymerizable monomer (E)). If the amount of the photopolymerization initiator to be used is less than 0.5% by weight, the resultant photocurable and thermosetting resin composition will exhibit poor sensitivity. Conversely, the amount of the photopolymerization initiator exceeding 20% by weight is not preferred because poor pattern shape will be obtained.

Further, besides the photopolymerization initiator (B) mentioned above, a photo-initiator aid such as tertiary amines like ethyl-N,N-(dimethylamino)benzoate, isoamyl-N,N-(dimethylamino)benzoate, pentyl-4-dimethylaminobenzoate, triethyl amine, and triethanol amine may be added to the composition. Moreover, a titanothene compound such as CGI-784 (product of Ciba Specialty Chemicals Inc.) and the like which exhibit absorption in a visible region may be added to promote the photochemical reaction.

As the thermosetting component (C), a polyfunctional epoxy compound having at least two epoxy groups in its molecule may be advantageously used. For example, bisphenol F type epoxy resins, bisphenol A type epoxy resins, phenol novolak type epoxy resins, cresol novolak type epoxy resins, naphthalene type epoxy resins, biphenyl type epoxy resins, alicyclic epoxy resins, and heterocyclic epoxy resins may be cited. However, the polyfunctional epoxy compound is not limited to these resins. In addition thereto, a polyfunctional oxetane compound having at least two oxetanyl groups in its molecule may be used.

The thermosetting compound (C) mentioned above is preferred to be used in an amount of 10 to 150 parts by weight, preferably 30 to 100 parts by weight, based on 100 parts by weight of the aforementioned photosensitive prepolymer (A).

Besides the components mentioned above, the photocurable and thermosetting resin composition of the present invention is preferred to be incorporated therein a thermosetting catalyst for the epoxy resin and the polyfunctional oxetane compound. As the thermosetting catalyst, for example, imidazole and imidazole derivatives such as 2-methylimidazole, 2-ethylimidazole, 2-ethyl-4-methylimidazole, 2-phenylimidazole, 4-phenylimidazole, 1-cyanoethyl-2-phenylimidazole, and 1-cyanoethyl-2-ethyl-4-methylimidazole; imidazoline derivatives such as 2-ethylimidazoline; amine compounds such as dicyandiamide, benzyldimethyl amine, 4-(dimethylamino)-N,N-dimethylbenzyl amine, 4-methoxy-N,N-dimethylbenzyl amine, 4-methyl-N,N-dimethylbenzyl amine; organic acid hydrazides such as dihydrazide adipate and dihydrazide sebacate; and phosphorus compounds such as triphenylphosphine may be cited. The thermosetting catalyst is not limited to the compounds cited above and any curing catalysts for epoxy resins and oxetane compounds and any compounds which can promote the reaction of an epoxy group and/or oxetanyl group with a carboxyl group may be used. The thermosetting catalysts may be used either singly or in the form of a mixture of two or more members. Furthermore, S-triazine derivatives which also act as an adhesiveness-imparting agent, such as guanamine, acetoguanamine, benzoguanamine, melamine, 2,4-diamino-6-methacryloyloxyethyl-S-triazine, 2-vinyl-4,6-diamino-S-triazine, isocyanuric acid adduct of 2-vinyl-4,6-diamino-S-triazine, isocyanuric acid adduct of 2,4-diamino-6-methacryloyloxyethyl-S-triazine may also be used. Preferably, the compound which also acts as an adhesiveness-imparting agent is used in combination with the thermosetting catalyst mentioned above. The amount of the thermosetting catalyst to be incorporated in the composition may be in the conventionally used range, for example, in the range of 0.1 to 20 parts by weight, preferably 0.5 to 15.0 parts by weight, based on 100 parts by weight of the photosensitive prepolymer (A) mentioned above.

The photocurable and thermosetting resin composition of the present invention containing the components described above, as occasion demands, allows incorporation therein of such a compound as adenine, vinyltriazine, dicyandiamide, o-tolyl biguanide, and melamine for the purpose of preventing a circuit of a printed circuit board, i.e. copper against oxidation. Further, for the purpose of enhancing the characteristics of the coating film such as adhesiveness, hardness, and resistance to soldering heat, the photocurable and thermosetting resin composition may further incorporate therein, as occasion demands, a well known and widely used inorganic filler such as barium sulfate, barium titanate, silicon oxide powder, amorphous silica, talc, clay, kaolin, magnesium carbonate, calcium carbonate, aluminum oxide, aluminum hydroxide, glass fiber, carbon fiber, and mica powder, and an organic filler such as a silicone powder, a nylon powder, and a urethane powder in an amount of not more than 300 parts by weight, preferably in the range of 5 to 200 parts by weight, based on 100 parts by weight of the photocurable components (A, E) mentioned above.

The composition of the present invention may further incorporate therein, as occasion demands, any of known and commonly used coloring agents (pigments and dyes) such as phthalocyanine blue, phthalocyanine green, iodine green, disazo yellow, crystal violet, titanium oxide, carbon black, and naphthalene black, any of known and commonly used thermal polymerization inhibitors such as hydroquinone, hydroquinone monomethyl ether, tert-butyl catechol, pyrogallol, and phenothiazine, any of known and commonly used thickening agents such as asbestos, finely powdered silica, organobentonite, and montmorillonite, silicone type, fluorine type, or macromolecular type anti-foaming agents and/or leveling agents, any of known and commonly used adhesiveness-imparting agents such as imidazole-based, thiazole-based, or triazole-based silane coupling agents, a dispersing agent, a flame-retardant, or any other additives.

A cured product of the photocurable and thermosetting resin composition of the present invention can be easily obtained in the same manner as a heretofore known method.

For instance, when the photocurable and thermosetting resin composition of the present invention described above is used in the formation of a solder resist of a printed circuit board, it is adjusted to a level of viscosity suitable for a particular coating method when necessary, then applied by the technique of screen printing, curtain coating, spray coating, roll coating, or the like to a printed circuit board having a circuit preparatorily formed thereon, and then subjected to a drying treatment at a temperature in the approximate range of 60 to 100° C., for example, to produce a tack-free coating film, as occasion demands. The coating film is then selectively exposed to actinic radiation through a photomask having a prescribed exposure pattern. Alternatively, the coating film can be exposed to a laser beam by projecting the laser beam directly on the coating film according to a prescribed pattern to draw an image. Then, the unexposed portion of the coating film is developed with an aqueous alkaline solution to form a resist pattern. The resist formed as described above is further thermally cured by subjecting to a heat treatment at a temperature in the approximate range of 140 to 180° C., for example, to obtain a resist film. By this heat treatment, in addition to the curing reaction of the aforementioned thermosetting components, the polymerization of the photosensitive components is promoted so that consequently produced resist film acquires improvements in various properties such as resistance to heat, resistance to solvents, resistance to acids, resistance to moisture absorption, PCT (pressure cooker) resistance, adhesiveness, and electrical properties.

As an aqueous alkaline solution to be used in the development mentioned above, aqueous alkaline solutions of potassium hydroxide, sodium hydroxide, sodium carbonate, potassium carbonate, sodium phosphate, sodium silicate, ammonia, amines, etc. can be used.

Suitable light sources which are used for the purpose of photocuring the composition are a low-pressure mercury vapor lamp, a medium-pressure mercury vapor lamp, a high-pressure mercury vapor lamp, an ultra-high-pressure mercury vapor lamp, a xenon lamp, and a metal halide lamp, for example. Besides, a laser beam may be used as the actinic rays for exposure of the film.

Now, the present invention will be more specifically described below with reference to experiments and working examples. Wherever “parts” and “%” are mentioned hereinbelow, they invariably refer to those based on weight unless otherwise specified.

Experiment (Measurement of Water Solubility in Various Solvents):

Into 100 g of each solvent shown in Table 1 put into a flask, distilled water was added so that it accounts for 0.1-100% by weight. The mixture kept at a liquid temperature of 25° C. was shaken for 5 minutes by a shaker, left standing for 10 minutes, and then visually examined to evaluate the state of the mixture. The criterion for evaluation is as follows.

◯: The solution is wholly transparent.

Δ: Although white particles can be found partially, the solution is almost transparent.

X: The whole of the solution is cloudy whitely or separation is found.

The results of the experiment are collectively shown in Table 1.

TABLE 1

| Amount of | | | | | |
|---|---|---|---|---|---|
| water added | Kind of solvent | | | | |
| (% by weight) | DPMA | PMA | DPM | CA | #150 |
| 0.1 | ◯ | ◯ | ◯ | ◯ | X |
| 1.0 | ◯ | ◯ | ◯ | ◯ | X |
| 2.0 | ◯ | ◯ | ◯ | ◯ | X |
| 2.5 | ◯ | ◯ | ◯ | ◯ | X |
| 3.0 | Δ | ◯ | ◯ | ◯ | X |
| 4.0 | Δ | ◯ | ◯ | ◯ | X |
| 5.0 | X | ◯ | ◯ | ◯ | X |
| 6.0 | X | Δ | ◯ | ◯ | X |
| 7.0 | X | X | ◯ | ◯ | X |
| 10.0 | X | X | ◯ | ◯ | X |
| 20.0 | X | X | ◯ | ◯ | X |
| 30.0 | X | X | ◯ | ◯ | X |
| 40.0 | X | X | ◯ | ◯ | X |
| 50.0 | X | X | ◯ | ◯ | X |
| 100.0 | X | X | ◯ | ◯ | X |

Remarks
DPMA: Dipropylene glycol monomethyl ether acetate
PMA: Propylene glycol monomethyl ether acetate
DPM: Dipropylene glycol monomethyl ether
CA: Diethylene glycol monoethyl ether acetate
#150: Petroleum solvent manufactured by Idemitsu Petrochemical Co., Ltd., IPSOL #150

It will be clear from the results shown in Table 1 that the critical value of the water solubility of dipropylene glycol monomethyl ether acetate (DPMA) having a boiling point of 209° C. is 2.5% by weight and that of propylene glycol monomethyl ether acetate (PMA) having a boiling point of 146° C. is 5.0% by weight. On the other hand, in the cases of dipropylene glycol methyl ether (DPM) having a boiling point of 190° C. and diethylene glycol monoethyl ether acetate (CA) having a boiling point of 217° C. there is no critical value up to 100% by weight of water addition (water is dissolved therein). The water solubility of IPSOL #150, petroleum solvent was less than 0.1% by weight. Then, in the following Examples the evaluation of the characteristics of a coating film was done by using DPMA, CA, PMA and a mixed solvent of CA and IPSOL #150 as a solvent.

### SYNTHESIS EXAMPLE 1

Into a flask equipped with a thermometer, a stirrer, a dropping funnel and a reflux condenser, 210 parts of cresol novolak type epoxy resin (EPICLON N-680 manufactured by Dainippon Ink and Chemicals Inc., epoxy equivalent: 210) and 250 parts of dipropylene glycol monomethyl ether acetate (DPMA) were charged and they were molten by heating. Then, 0.1 part of hydroquinone as a polymerization inhibitor and 2.0 parts of triphenylphosphine as a reaction catalyst were added thereto. The resultant mixture was heated to 95-105° C., 72 parts of acrylic acid was gradually added dropwise thereto, and they were left reacting for about 16 hours until an acid value thereof becomes under 3.0 mg KOH/g. The resultant reaction product was cooled to 80-90° C., 137 parts of hexahydrophthalic anhydride was added thereto, and the mixture was left reacting for about 6 hours until the absorption peak (1780 cm⁻¹) of the acid anhydride measured by the infrared absorption analysis disappeared to obtain a photosensitive prepolymer having a solid content of 63%.

### SYNTHESIS EXAMPLE 2

Into a flask equipped with a thermometer, a stirrer, a dropping funnel and a reflux condenser, 210 parts of cresol novolak type epoxy resin (EPICLON N-680 manufactured by Dainippon Ink and Chemicals Inc., epoxy equivalent: 210) and 250 parts of diethylene glycol monoethyl ether acetate (CA) were charged and they were molten by heating. Then, 0.1 part of hydroquinone as a polymerization inhibitor and 2.0 parts of triphenylphosphine as a reaction catalyst were added thereto. The resultant mixture was heated to 95-105° C., 72 parts of acrylic acid was gradually added dropwise thereto, and they were left reacting for about 16 hours until an acid value thereof becomes under 3.0 mg KOH/g. The resultant reaction product was cooled to 80-90° C., 137 parts of hexahydrophthalic anhydride was added thereto, and the mixture was left reacting for about 6 hours until the absorption peak (1780 cm⁻¹) of the acid anhydride measured by the infrared absorption analysis disappeared to obtain a photosensitive prepolymer having a solid content of 63%.

### SYNTHESIS EXAMPLE 3

Into a flask equipped with a thermometer, a stirrer, a dropping funnel and a reflux condenser, 210 parts of cresol novolak type epoxy resin (EPICLON N-680 manufactured by Dainippon Ink and Chemicals Inc., epoxy equivalent: 210) and 250 parts of propylene glycol monomethyl ether acetate (PMA) were charged and they were molten by heating. Then, 0.1 part of hydroquinone as a polymerization inhibitor and 2.0 parts of triphenylphosphine as a reaction catalyst were added thereto. The resultant mixture was heated to 95-105° C., 72 parts of acrylic acid was gradually added dropwise thereto, and they were left reacting for about 16 hours until an acid value thereof becomes under 3.0 mg KOH/g. The resultant reaction product was cooled to 80-90° C., 137 parts of hexahydrophthalic anhydride was added thereto, and the mixture was left reacting for about 6 hours until the absorption peak (1780 cm⁻¹) of the acid anhydride measured by the infrared absorption analysis disappeared to obtain a photosensitive prepolymer having a solid content of 63%.

### SYNTHESIS EXAMPLE 4

Into a flask equipped with a thermometer, a stirrer, a dropping funnel and a reflux condenser, 210 parts of cresol novolak type epoxy resin (EPICLON N-680 manufactured by Dainippon Ink and Chemicals Inc., epoxy equivalent: 210) and 100 parts of diethylene glycol monoethyl ether acetate (CA) were charged and they were molten by heating. Then, 0.1 part of hydroquinone as a polymerization inhibitor and 2.0 parts of triphenylphosphine as a reaction catalyst were added thereto. The resultant mixture was heated to 95-105° C., 72 parts of acrylic acid was gradually added dropwise thereto, and they were left reacting for about 16 hours until an acid value thereof becomes under 3.0 mg KOH/g. The resultant reaction product was cooled to 80-90° C., 137 parts of hexahydrophthalic anhydride and 150 parts of the petroleum solvent, IPSOL #150 manufactured by Idemitsu Petrochemical Co., Ltd. were added thereto, and the mixture was left reacting for about 6 hours until the absorption peak (1780 cm⁻¹) of the acid anhydride measured by the infrared absorption analysis disappeared to obtain a photosensitive prepolymer having a solid content of 63%.

### EXAMPLE 1

A solution of a photocurable and thermosetting resin composition was prepared by preparatorily mixing 100 parts of the photosensitive prepolymer obtained in Synthesis Example 1 with 1 part of phthalocyanine green, 100 parts of barium sulfate, 23 parts of cresol novolak type epoxy resin (N-695 manufactured by Dainippon Ink and Chemicals Inc.), 13 parts of acrylic ester monomer (dipentaerythritol hexaacrylate), 4 parts of melamine, 11 parts of Irgacure 907 (photopolymerization initiator manufactured by Ciba Specialty Chemicals Inc.), 4 parts of KS-66 (a silicone type anti-foaming agent manufactured by Shinetsu Chemical Industry Co., Ltd.), and 22 parts of DPMA and kneading them with a three-roll mill.

### COMPARATIVE EXAMPLE 1

A solution of a photocurable and thermosetting resin composition was prepared by preparatorily mixing 100 parts of the photosensitive prepolymer obtained in Synthesis Example 2 with 1 part of phthalocyanine green, 100 parts of barium sulfate, 23 parts of cresol novolak type epoxy resin (N-695 manufactured by Dainippon Ink and Chemicals Inc.), 13 parts of acrylic ester monomer (dipentaerythritol hexaacrylate), 4 parts of melamine, 11 parts of Irgacure 907 (photopolymerization initiator manufactured by Ciba Specialty Chemicals Inc.), 4 parts of KS-66 (a silicone type anti-foaming agent manufactured by Shinetsu Chemical Industry Co., Ltd.), and 22 parts of CA and kneading them with a three-roll mill.

### COMPARATIVE EXAMPLE 2

A solution of a photocurable and thermosetting resin composition was prepared by preparatorily mixing 100 parts of the photosensitive prepolymer obtained in Synthesis Example 3 with 1 part of phthalocyanine green, 100 parts of barium sulfate, 23 parts of cresol novolak type epoxy resin (N-695 manufactured by Dainippon Ink and Chemicals Inc.), 13 parts of acrylic ester monomer (dipentaerythritol hexaacrylate), 4 parts of melamine, 11 parts of Irgacure 907 (photopolymerization initiator manufactured by Ciba Specialty Chemicals Inc.), 4 parts of KS-66 (a silicone type anti-foaming agent manufactured by Shinetsu Chemical Industry Co., Ltd.), and 22 parts of PMA and kneading them with a three-roll mill.

### COMPARATIVE EXAMPLE 3

A solution of a photocurable and thermosetting resin composition was prepared by preparatorily mixing 100 parts of the photosensitive prepolymer obtained in Synthesis Example 4 with 1 part of phthalocyanine green, 100 parts of barium sulfate, 23 parts of cresol novolak type epoxy resin (N-695 manufactured by Dainippon Ink and Chemicals Inc.), 13 parts of acrylic ester monomer (dipentaerythritol hexaacrylate), 4 parts of melamine, 11 parts of Irgacure 907 (photopolymerization initiator manufactured by Ciba Specialty Chemicals Inc.), 4 parts of KS-66 (a silicone type anti-foaming agent manufactured by Shinetsu Chemical Industry Co., Ltd.), and 22 parts of IPSOL #150 and kneading them with a three-roll mill.

Each of the coating films prepared from the aforementioned photocurable and thermosetting resin compositions obtained in Example 1 and Comparative Examples 1-3 respectively was tested and evaluated for the scum resistance, break point, tackiness, and film chracteristics (resistance to soldering heat, solvent resistance, and chemical resistance) in accordance with the following methods.

Each of the cured films subjected to the evaluation of film chracteristics was prepared by applying the photocurable and thermosetting composition to a substrate which had been subjected to a surface treatment in advance by the screen printing method to form a coating film of 30 μm thickness (before drying), preliminarily drying the coating film at 80° C. for 30 minutes, thereafter irradiating the coating film with ultraviolet rays at an irradiation dose of 500 mJ/cm², then developing the coating film for 60 seconds with an aqueous 1% sodium carbonate solution, and postcuring the film at 150° C. for 60 minutes.

(1) Test for Scum

The photocurable and thermosetting composition was applied to a substrate which had been subjected to a surface treatment in advance by the screen printing method to form a coating film of 30 μm thickness (before drying). The substrate was placed in a thermostatic chamber (30° C., 80% R.H.) for 15 minutes. Thereafter, the coating film on the substrate was preliminarily dried in a hot-air drying oven at 80° C. for 30 minutes and then developed for 60 seconds with an aqueous 1% sodium carbonate solution sprayed under a pressure of 0.2 MPa. After the development, the residue of the resist was visually examined.

◯: Total absence of residue of resist

Δ: Presence of residue of resist

X: Presence of residue of resist on the entire surface

(2) Break Point

The photocurable and thermosetting composition was applied to a substrate which had been subjected to a surface treatment in advance by the screen printing method to form a coating film of 30 μm thickness (before drying). The coating film on the substrate was preliminarily dried in a hot-air drying oven at 80° C. for 30 minutes and then developed with an aqueous 1% sodium carbonate solution sprayed under a pressure of 0.2 MPa. The period of time (break point) from the start of spraying to the point at which the coating film was entirely removed and the substrate can be seen was measured.

(3) Tackiness

A film was placed in contact with the coating film which had been made in the same way as in the test for scum mentioned above till pre-drying. The blocking tendency of the film when removed from the coating film was evaluated.

◯: Absence of blocking tendency of the film

Δ: Presence of blocking tendency of the film

X: The coating film was transferred onto the film.

(4) Resistance to Soldering Heat

The cured film was subjected to the cycle comprising immersion in a soldering bath set in advance at 260° C. for 10 seconds and a peeling test with a cellophane adhesive tape in accordance with the testing method specified in JIS (Japanese Industrial Standard) C 6481. The cured films subjected to one to three cycles of this treatment were visually examined to evaluate the state of the film.

◯: No discernible change was found after three cycles.

Δ: A discernible change was found after two cycles.

X: Separation of the film was found after one cycle.

(5) Solvent Resistance

After immersion in PMA for 30 minutes, the cured film was visually examined to evaluate the state of the film.

◯: Absolutely no discernible change was found.

Δ: Presence of change was found.

X: The film was swollen and separated from the substrate.

(6) Chemical Resistance (Acid Resistance)

After immersion in an aqueous 10 vol. % sulfuric acid solution for 30 minutes, the cured film was visually examined to evaluate the state of the film.

◯: Absolutely no discernible change was found.

Δ: Presence of change was found.

X: The film was swollen and separated from the substrate.

The test results are shown in Table 2.

TABLE 2

| | Example | Comparative Example | | |
|---|---|---|---|---|
| Properties | 1 | 1 | 2 | 3 |
| Scum Test | ◯ | X | Δ | Δ |
| Break Point | 20 | 18 | 24 | 42 |
| | seconds | seconds | seconds | seconds |
| Tackiness | ◯ | ◯ | ◯ | ◯ |
| Resistance to | ◯ | ◯ | ◯ | ◯ |
| Soldering Heat | | | | |
| Solvent Resistance | ◯ | ◯ | ◯ | ◯ |
| Chemical | ◯ | ◯ | ◯ | ◯ |
| Resistance | | | | |

As being clear from the test results shown in Table 2, in the case of Example 1 using DPMA which exhibits the critical value of the water solubility of not more than 3.0% by weight as a solvent component, the coating film showed excellent results in tackiness, resistance to soldering heat, solvent resistance, and chemical resistance and generation of no scum. In the case of Comparative Example 1 using CA which exhibits no critical value up to 100% of the amount of water addition (water is dissolved therein), though the coating film was satisfactory in other characteristics, the scum generated on the entire surface thereof. On the other hand, in the case of Comparative Example 2 using PMA which exhibits the critical value of the water solubility of 5% by weight as a solvent component, the residual substance of the resist was produced, though it was not so severe as the case of Comparative Example 1 using CA. Further, in the case of Comparative Example 3 using IPSOL #150 of which water solubility is less than 0.1% byweight in place of 50% by weight or more of CA in Comparative Example 1, though the degree of generation of the scum has been improved as compared with the Comparative Example 1, the break point became long.

As describe above, since the photocurable and thermosetting resin composition of the present invention contains as a main solvent ingredient the alkyl ether ester compound of propylene glycol which exhibits the critical value of the water solubility at 25° C. in the range of 3.0 to 0.1% by weight, it allows the suppression of generation of a scum and is effective in preventing the soldering and plating from poor adhesion. Further, the present invention provides an eco-friendly photocurable and thermosetting resin composition which is capable of coping with the problem of dioxin and the solvent regulations and is useful in the formation of a solder resist or the like of a printed circuit board and formation of various resin insulating layers.

While certain specific working examples have been disclosed herein, the invention may be embodied in other specific forms without departing from the spirit or essential characteristics thereof. The described examples are therefore to be considered in all respects as illustrative and not restrictive, the scope of the invention being indicated by the appended claims rather than by the foregoing description and all changes which come within the meaning and range of equivalency of the claims are, therefore, intended to be embraced therein.

What is claimed is:

1. A photocurable and thermosetting resin composition comprising a photocurable component, a thermosetting component, and a solvent component, wherein the solvent component contains a compound which exhibits a critical value of the water solubility at 25° C. of 3.0 to 0.1% by weight, and which is represented by the following general formula (1):
R¹COO—(C₃H₆O)ₙ—R² (1)
wherein, R¹ and R² may be identical or different from each other and independently represent an alkyl group having 1 to 4 carbon atoms, and n represents an integer of 1 or 2.

2. The composition according to claim 1, wherein said compound represented by the general formula (1) exhibits a critical value of the water solubility at 25° C. of 2.5 to 0.1% by weight.

3. The composition according to claim 1, wherein said compound represented by the general formula (1) exhibits a boiling point of not less than 150° C.

4. The composition according to claim 1, wherein said solvent component contains said compound represented by the general formula (1) in the proportion of not less than 50% by weight.

5. The composition according to claim 1, wherein said compound represented by the general formula (1) is dipropylene glycol monoalkyl ether acetate.

6. The composition according to claim 1, wherein said compound represented by the general formula (1) is dipropylene glycol monomethyl ether acetate.

7. The composition according to claim 1, which contains (A) a photosensitive prepolymer having a carboxyl group and at least two ethylenically unsaturated bonds in its molecule, (B) a photopolymerization initiator, (C) a thermosetting compound, (D) a solvent component in such proportions that said component (B) accounts for a proportion in the range of 0.5 to 20 parts by weight and said component (C) accounts for a proportion in the range of 10 to 150 parts by weight, respectively based on 100 parts by weight of said component (A), and said component (D) accounts for a proportion in the range of 5 to 500 parts by weight, based on 100 parts by weight of the total of said components (A) and (C).

8. The composition according to claim 7, further comprising (E) a photopolymerizable monomer in an amount of not more than 60 parts by weight, based on 100 parts by weight of said photosensitive prepolymer (A).

9. The composition according to claim 7, further comprising a thermosetting catalyst in an amount of 0.1 to 20 parts by weight, based on 100 parts by weight of said photosensitive prepolymer (A).
